(19) United States
(12) Patent Application Publication
(10) Pub. No.: US 2008/0003066 A1
(43) Pub. Date: Jan. 3, 2008

(54) CONVEX RASP

(76) Inventor: Arne Haugaard, Hvalsoe (DK)

Correspondence Address: BAKER & MCKENZIE LLP, Pennzoil Place, South Tower, 711 Louisiana, Suite 3400, HOUSTON, TX, 77002-2716, US

(21) Appl. No.: 11/427,440

(22) Filed: Jun. 29, 2006

(51) Int. Cl. B23D 71/04

(52) U.S. Cl. 407/29.1; 407/29.14; 407/29.15

(57) ABSTRACT

An improved concave rasp that can be used to smooth any concave surface, such as under a hoof, having a handle approximately perpendicularly affixed at about the middle of a rasp that is convex both along its length and in cross section. The underside of the rasp has a rounded end, thus being suitable for applying pressure there against. Another embodiment of the invention is an improved tooth design, comprising a tooth blade, rather than individual teeth, thus providing much increased biting edge with increased durability.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A COMPACT DISK APPENDIX

Not applicable.

### FIELD OF THE INVENTION

The invention relates generally to rasps and, in particular, to a curved rasp designed to smooth a concave surface, such as under an equine hoof.

### BACKGROUND OF THE INVENTION

In its natural environment a horse travels an average of 15-30 km per day over varied terrain. The hoof remains supple and elastic by daily soaking that occurs when the horse drinks. It doesn't have, or need, any type of artificial moistening agent. The hooves naturally adjust to the terrain and both horn growth and wear are in balance. In this way, the optimal conformation and shape of the hoof is naturally maintained.

Many strive to achieve this natural trimming of the hoof, and the “barefoot” horse movement is catching on throughout the America's, Europe, Australia and beyond. As promoted by Dr. Hiltrud Strasser:
“Most of the common health problems affecting domestic horses are a direct result of man made violations of the horse's natural life style and can be prevented through removal of the cause and a return to a natural lifestyle.”

No trimming is actually “natural,” however. The only natural trim is the one a horse gives himself, living in wild conditions. In the care of humans, horses always fall short of their natural and biologically required amount of movement. Therefore, in order to imitate the natural wear on the hoof, it is necessary to trim it quite frequently. By weekly trimming we begin to mimic the daily wear of wild hooves.

Many horse owners are applying the natural trim methods of Strasser, Jackson and others and for most the job is arduous and exhausting. High quality, affordable tools are essential—both to make the job as easy as possible, and also to encourage frequent trimming.

One important part of the trim is to smooth the bars, preventing the protrusions from applying excess pressure to the sole, and to remove excess sole and smooth the concave underside of the foot. In the past, this has been done with the hoof knife, a tool that requires constant sharpening and considerable hand strength to use, and presents considerable risk of injury to the inexperienced farrier. A better tool requiring less hand strength and presenting a less hazardous edge would be desirable.

U.S. Pat. No. 644,020 describes one such tool. It is an oval rasp that is convex both along its length and in cross section. The rasp has two handles, one posterior for use in drawing the rasp across the hoof, and the other a short handle at the anterior end for applying pressure to the rasp, thus providing a deeper cut. This rasp uses teeth that project in both directions, switching direction somewhere about the mid line, and allowing rasping in both directions. This rasp is a very useful improvement over the prior art flat rasps, but its use requires two hands, a difficult task when must also hold the hoof in position.

Danish patent DK200400738 describes another such tool. It describes a curved rasp of about ¾-1 by 4-5 inches that is curved in two dimensions—along its length and in cross section—and thus fits perfectly into the concave hoof sole. The tool is operated by one hand drawing the tool across the sole and applying pressure to the area to be adjusted. The rasp thus allows the farrier to easily remove excess sole and the protruding bars by the action of the curved rasp. However, this rasp also requires considerable hand strength to use, an issue particularly important to women farriers. The teeth also dull and since a rasp typically cannot be resharpened, the rasp must be replaced.

What is needed in the art is an improved rasp that can be used with one hand, but with less hand strength causing less fatigue, and has improved durability.

### BRIEF SUMMARY OF THE INVENTION

The invention is generally directed to a convex rasp that can be used to smooth any concave surface.

In one embodiment, the invention is an improved “nasp,” which is a combination kNife and rASP, for use on the underside of a hoof. The improved nasp allows increased leverage of the strength of the arm to be applied to the nasp, thus reducing hand fatigue. An additional improvement is the use of a tooth design that provides much increased cutting surface, thus facilitating the nasp action, reducing fatigue and improving durability of the cutting edge.

In one embodiment, the invention is a rasp with a handle positioned approximately midway along the rasp. The handle can be integral, welded or otherwise attached thereto, and can also be covered with a comfortable, molded plastic cover. The rasp itself is curved along the longitudinal axis and in cross section, providing a convex biting surface that fits perfectly into the concave bottom surface of a hoof.

The underside of the rasp surface is shaped to receive the palm of the hand, so that pressure can be applied thereto when in use. The prior rasp design (FIG. 1) made no accommodation for the hand on the undersurface, making it difficult to apply pressure to the end of the rasp. In the improved nasp, the palm (particularly the outer meaty edge of the palm) applies pressure on the rounded inner end of the rasp and relieves the need to apply pressure along the handle, thus spreading the workload and reducing fatigue.

The palm rest can be made integrally with the rasp surface by folding back the metal to form a nicely rounded edge without protrusions. The end can be otherwise rounded, for example, a separate palm rest can be welded thereto or the edges can be smoothed by filling and/or grinding. However, in a preferred embodiment, the palm rest is formed integrally with the plastic handle cover, thus minimizing the weight of the rasp and providing a smooth and comfortable surface for hand contact.

Another embodiment of the invention is a rasp with an improved tooth design. The improved biting edges are not individual teeth, but rather a grooved “edge” or “blade,” that provides much increased cutting surface over the traditional saw tooth rasp tooth design. In preferred embodiments, the grooves are arranged at between 30-45 degrees from the longitudinal axis, and may optionally have additional notches therein. The improved tooth blades are particularly beneficial for a moist and flexible hoof, whereas the prior tooth design was better suited to a harder hoof. Although the improved teeth were invented for use in a nasp, they can also be applied to other rasps and files for general use.

In yet another embodiment, the tooth designs are combined so that either style of tooth may be used by the farrier, depending on the hardness of the hoof. Thus, the tooth blade may be used at one end of the rasp, and the traditional tooth design may be used at the other end. Alternatively, the rasp can be made slightly wider, and the tooth design switched along the midline of the rasp.

The rasp can be formed in the manner well known in the art, for example as described in U.S. Pat. No. 5,919,007, U.S. Pat. No. 5,996,698, U.S. Pat. No. 4,598,447, U.S. Pat. No. 3,509,611, U.S. Pat. No. 2,058,912, U.S. Pat. No. 1,785,836 GB254247, GB456868, and GB189516317, and the like. However, in a preferred embodiment the rasp is made as described in Example 2.

The rasp can be made of materials known in the art, provided they can be shaped as needed and are sufficiently hard so as to provide a durable cutting edge. Suitable materials include metals, such as hardened tempered steel, ceramics, metal powders, glass, carbon fibers, diamond coated, and the like.

The above summary of the present invention is not intended to represent each embodiment or every aspect of the present invention.

### BRIEF DESCRIPTION OF THE DRAWINGS

FIG. 1 is the prior art nasp showing the sharp ends, preventing pressure from being comfortably applied thereto.

FIG. 2 is a view of the improved rasp teeth, showing the grooved, and in this case notched, tooth blades, with a close-up of the blades shown to the left.

FIG. 3 is a view of the nasp before the rounded under surface is added, thus clearly showing that the cross section of the nasp is also convex.

FIG. 4 is one embodiment of the invention showing the ledge where hand pressure can be applied.

FIG. 5 is another embodiment of the nasp showing an integral handle and palm rest, preferably made of a moldable material such as plastic or resin.

FIG. 6 shows the rasp in use and the hand comfortably applying pressure on the palm rest.

FIG. 7 shows a combination tooth design.

FIG. 8 is another embodiment of the invention showing an integral handle, palm rest and rasp surface.

FIG. 9 is another embodiment of the invention showing the handle rotated 90 degrees and providing a palm rest along its entire length.

### DETAILED DESCRIPTION OF THE INVENTION

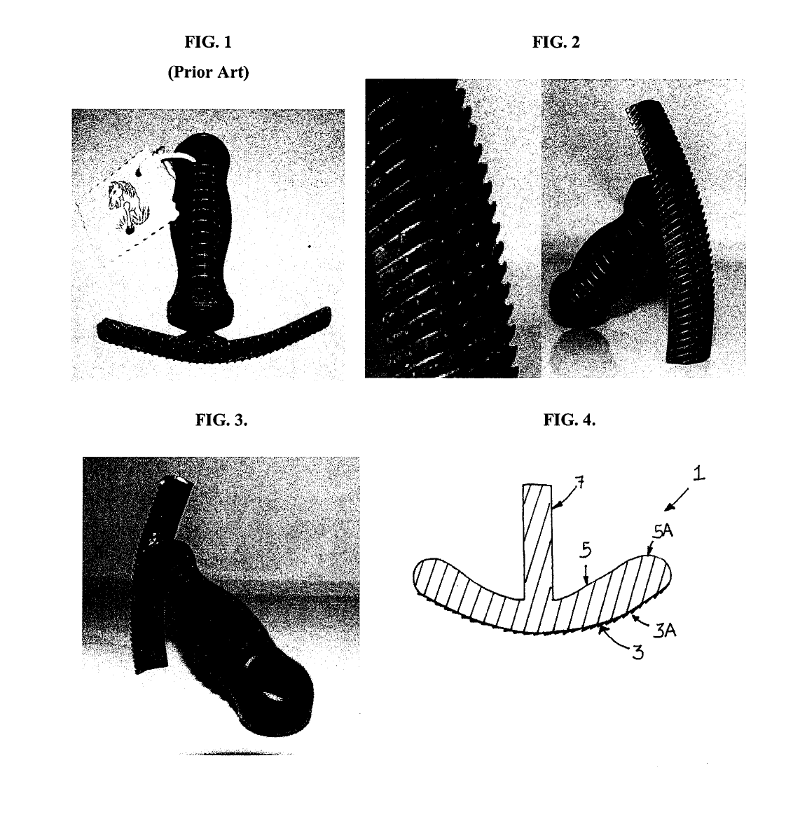

The invention can be best understood with reference to the exemplary drawings. FIG. 1 shows the prior art nasp, with the sharp underside that prevents the hand from applying pressure at the nasp end. It also shows one of several traditional rasp tooth designs. The nasp is drawn across the underside of the hoof to smooth the bars and trim the sole.

FIG. 2 shows the rasp with improved tooth design. Instead of individual teeth, a groove is provided thus creating a “blade” like effect. Because there is much more cutting edge, the rasp will stay sharp longer and will be more efficient.

FIG. 3 shows the underside of the nasp, indicating that the nasp is convex in cross section. This view also clearly indicates the need for a palm rest, so that pressure may be applied to the end of the nasp when in use.

FIG. 4 is a schematic representation of the invention showing the ledge where hand pressure can be applied. The nasp 1 has a rasp 3 with cutting teeth 3A. The rasp 3 is convex along its length and also in cross section (not shown here). Thus, it is curved to fit nicely into the concave hoof underside. The rasp 3 has a back surface 5 with rounded ends 5A. The curvature of the rounded end 5A is variable, and can be any shape against which the hand can be comfortably pressed. A handle 7 is affixed to the nasp in about the middle and at approximately a right angle thereto.

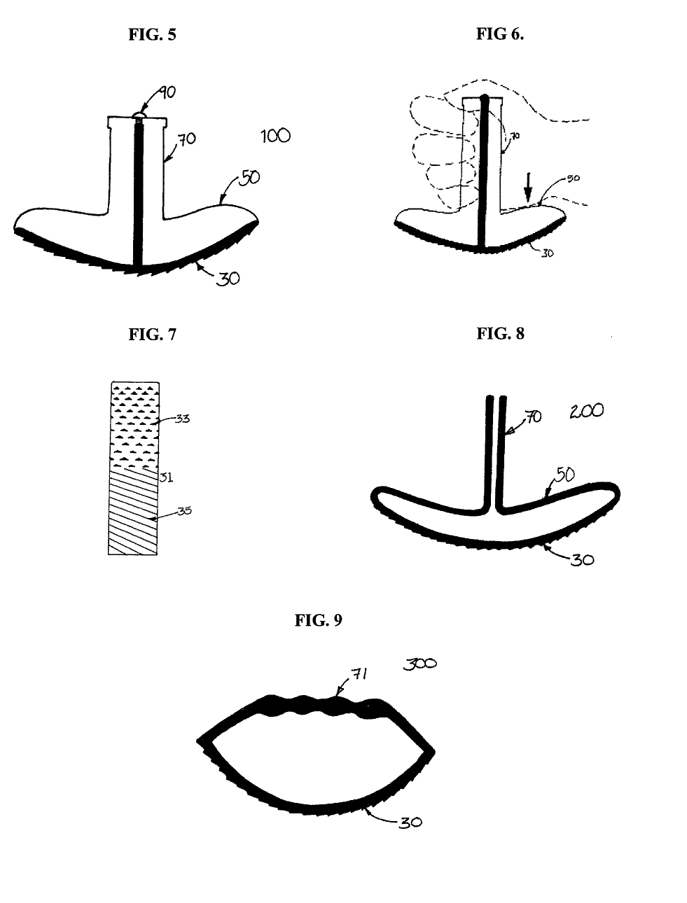

FIG. 5. is a schematic representation of another embodiment of the nasp 100 with rasp surface 30. It shows an integral handle 70 and palm rest 50, preferably made of a moldable material such as plastic or resin. In this instance, the moldable handle and palm rest is held to the nasp 100 with a screw 90, but other attachment means, including snap-fit, glue, and fasteners are contemplated. FIG. 6 shows the same rasp in use with the hand applying pressure to the palm rest.

FIG. 7 shows a combination tooth design on the rasp surface 31. In this case the nasp is turned around to the appropriate end for use on either a softer sole (bladed tooth design 35) or a harder sole (traditional tooth design 33)

FIG. 8. is another embodiment of the invention 200 showing an integral handle 70, palm rest 50 and rasp surface 30. A plastic cover may also be added to the handle for comfort.

FIG. 9 shows another embodiment 300 with a handle 71 roughly parallel to the rasp surface 30, where pressure can be applied along the entire length of the handle.

### EXAMPLE 2

### Rasp Manufacture

The improved rasp is produced in the curved shape with the blade like teeth made primarily of metals or alloys of steel and aluminum, titanium, silicium, and the like, but in the future also by ceramics, metal powder (powder pressure formed and baked). Suppliers of “raw” materials are manufactures of high quality tools, metal alloys, but can also be manufactures of carbon fibers, ceramic materials and the like.

The shape of the rasp is then obtained by applying heat (enough to make metal moldable) and the needed force necessary to shape the material over an object/tool/form. The working part is then cut to the needed measures and handles are welded or otherwise attached to the working part of the rasp. A certain metallurgic expertise is necessary in order to secure the correct hardness and wear resistance for the working part.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

1. A hand held rasp, comprising a rasp having a back surface and a rasp surface with a single handle operatively attached approximately midway to the back surface, wherein the rasp surface is convex along its longitudinal length and in cross section and has teeth, and wherein the back surface is configured to have a palm rest.

2. The rasp of claim 1 wherein the teeth are grooved blade teeth.

3. The rasp of claim 2 wherein the grooved blade teeth also have notches.

4. The rasp of claim 2, wherein the grooves are angled between 30-45 degrees from the longitudinal axis of the rasp surface.

5. The rasp of claim 3, wherein the grooves are angled between 30-45 degrees from the longitudinal axis of the rasp surface.

6. The rasp of claim 4, wherein the handle is perpendicularly affixed to the back surface of the rasp.

7. The rasp of claim 5, wherein the handle is perpendicularly affixed to the back surface of the rasp.

8. (canceled)

9. (canceled)

10. A hand-held rasp, comprising a rasp having a rasp surface and a back surface with a single handle operatively attached approximately midway to the back surface, wherein the rasp surface is convex along its longitudinal length and in cross section, and wherein the rasp surface has grooved blade teeth.

11. The rasp of claim 10 wherein the grooved blade teeth also have notches.

12. The rasp of claim 10, wherein the grooves are angled between 30-45 degrees from the longitudinal axis of the rasp surface.

13. The rasp of claim 11, wherein the grooves are angled between 30-45 degrees from the longitudinal axis of the rasp surface.

14. The rasp of claim 12, wherein the handle is perpendicularly affixed to the back surface of the rasp.

15. The rasp of claim 13, wherein the handle is perpendicularly affixed to the back surface of the rasp.

16. (canceled)

17. (canceled)

18. A hand held rasp, comprising a rasp having a back surface and a rasp surface with a single handle operatively attached substantially parallel to the back surface, wherein the rasp surface is convex along its longitudinal length and in cross section and has teeth, and wherein the handle is configured to have a palm rest.

19. A hand-held rasp, comprising a rasp having a rasp surface and a back surface with a single handle operatively attached approximately midway to back surface, wherein the rasp surface is convex along its longitudinal length and in cross section, and wherein the rasp surface has grooved blade teeth.
